(19) United States
(12) Patent Application Publication
(10) Pub. No.: US 2026/0178968 A1
(43) Pub. Date: Jun. 25, 2026

(54) APPLYING A SPARSE-DENSE-SPARSE METHODOLOGY TO LANGUAGE MODELS

(71) Applicant: XILINX, INC., San Jose, CA (US)

(72) Inventors: Xiandong ZHAO, Beijing (CN); Zeping LI, Beijing (CN); Dong LI, Beijing (CN); Lu TIAN, Beijing (CN); Ashish SIRASAO, San Jose, CA (US); Emad BARSOUM, Sammamish, WA (US); Guanchen LI, Beijing (CN)

(21) Appl. No.: 19/032,998

(22) Filed: Jan. 21, 2025

Related U.S. Application Data
(63) Continuation of application No. PCT/CN2024/141112, filed on Dec. 20, 2024.

(51) Int. Cl. G06N 20/00

(52) U.S. Cl. CPC G06N 20/00

(57) ABSTRACT

Embodiments herein describe a sparse-dense-sparse (SDS) process that achieves a better pruning scheme that benefits from pruning-friendliness relative to one-shot pruning schemes. The SDS process performs a first pruning to generate a sparse ML model followed by reconstruction to generate a re-dense ML model, followed by a second pruning to generate another sparse ML model. By pruning a ML model and then re-constructing the ML model, the ML model can be made more pruning-friendly by performing data and/or weight regularization. As a result, performing the second pruning in the SDS process can result in a smoother weight distribution and lower perplexity relative to one-shot pruning.

### TECHNICAL FIELD

Examples of the present disclosure apply a sparse-dense-sparse (SDS) methodology to compress machine learning (ML) models.

### BACKGROUND

Pre-trained language models (PLMs) have revolutionized various applications in natural language processing. However, the considerable size of PLMs (e.g., the number of weights) results in notable drawbacks, such as increased latency and energy consumption. Compression methods for vision models such as convolutional neural networks, which perform pre-training, compression, and fine-tuning workflow with quantization or pruning may entail substantial time and energy costs for PLMs due to their massive training requirements.

Recent pruning research has introduced one-shot compression techniques for PLMs. These methods can compress up to 50% of the parameters in the fully connected layers of ultra-large PLMs with negligible impact on performance. However, their effectiveness diminishes when applied to compact PLMs, which are usually more thoroughly trained.

For instance, one pruning method yields a perplexity value of 31.58 when applied to prune 50% of the weights in the Open Pretrained Transformer (OPT)-350M. This score is worse than the 27.66 perplexity value observed in OPT-125M, a dense model with roughly half the parameters of OPT-350M (where a lower perplexity value represents higher accuracy). Furthermore, when stricter sparsity constraints are employed, such as 2:4 or 4:8 sparse configurations for computational acceleration, the performance deteriorates even further.

### SUMMARY

One embodiment described herein is a computing system that includes one or more processors and memory storing one or more applications configured to, when executed by the one or more processors, perform operations. The operations include pruning a machine learning (ML) model to generate a sparse ML model, reconstructing the pruned ML model to generate a re-dense ML model, and pruning the re-dense ML model.

One embodiment described herein is a method that includes pruning, using a computing system, a ML model to generate a sparse ML model; reconstructing, using the computing system, the pruned ML model to generate a re-dense ML model; and pruning, using the computing system, the re-dense ML model.

One embodiment described herein is a non-transitory computer readable medium storing instructions that, when executed by one or more processors, causes the one or more processors to, individually or collectively perform operations. The operations include pruning a ML model to generate a sparse ML model, reconstructing the pruned ML model to generate a re-dense ML model, and pruning the re-dense ML model.

### BRIEF DESCRIPTION OF THE DRAWINGS

So that the manner in which the above recited features can be understood in detail, a more particular description, briefly summarized above, may be had by reference to example implementations, some of which are illustrated in the appended drawings. It is to be noted, however, that the appended drawings illustrate only typical example implementations and are therefore not to be considered limiting of its scope.

FIG. 1 illustrates a SDS process for a machine learning model, according to one embodiment.

FIG. 2 is a flowchart for a SDS process, according to one embodiment.

FIG. 3 illustrates distributions associated with the SDS process, according to one embodiment.

FIG. 4 illustrates error accumulation and weight regularization according to one embodiment.

FIG. 5 illustrates results of iteratively applying the SDS framework using static and dynamic samples, according to one embodiment.

To facilitate understanding, identical reference numerals have been used, where possible, to designate identical elements that are common to the figures. It is contemplated that elements of one example may be beneficially incorporated in other examples.

### DETAILED DESCRIPTION

Various features are described hereinafter with reference to the figures. It should be noted that the figures may or may not be drawn to scale and that the elements of similar structures or functions are represented by like reference numerals throughout the figures. It should be noted that the figures are only intended to facilitate the description of the features. They are not intended as an exhaustive description of the embodiments herein or as a limitation on the scope of the claims. In addition, an illustrated example need not have all the aspects or advantages shown. An aspect or an advantage described in conjunction with a particular example is not necessarily limited to that example and can be practiced in any other examples even if not so illustrated, or if not so explicitly described

Embodiments herein describe a sparse-dense-sparse (SDS) process or framework that achieves a better pruning scheme that benefits from pruning friendliness relative to one-shot pruning schemes. The SDS process performs a first pruning to generate a sparse ML model followed by reconstruction to generate a re-dense ML model, followed by a second pruning to generate another sparse ML model. This scheme can be beneficial for both large and compact PLMs, although better results may be achieved on compact PLMs. Compact PLMs cover not only undersized language models but also more fully trained models. On one hand, compact PLMs are less over-parameterized and naturally harder to compress. On the other hand, PLMs are not designed to be aware of subsequent pruning since they lack pruning-related regularization during pre-training. As a result, pruning compact PLMs while maintaining their performance proves challenging. However, by pruning a PLM and then re-constructing the PLM, the PLM can be made more pruning-friendly by performing data and/or weight regularization. As a result, performing the second pruning in the SDS process results in a smoother weight distribution and lower perplexity relative to one-shot pruning. This offers technical advantages such as reducing model size (e.g., the amount of memory used in the computing system to store the model) and computation (e.g., the amount of compute resources used to execute the model).

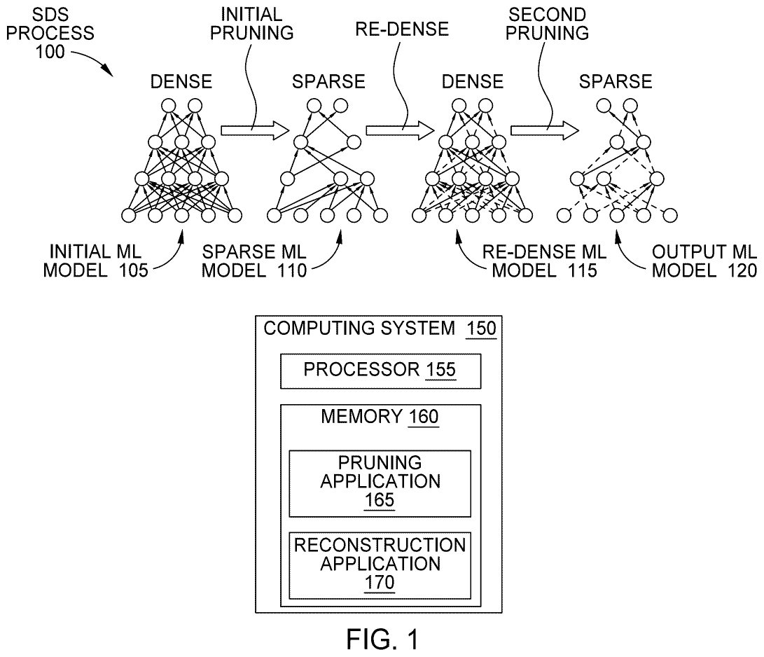

FIG. 1 illustrates a SDS process 100 for a pre-trained ML model, according to one embodiment. In this example, the SDS process 100 includes three processing steps. In the first step, an initial (trained) ML model 105 is pruned to form a sparse ML model 110. This model is then reconstructed to form a re-dense ML model 115 (e.g., a model with the same (or similar) number of weights and neurons as the initial ML model 105).

When reconstructing the ML model, the SDS process 100 can make the re-dense ML model more pruning-friendly. As discussed above, many training algorithms do not consider pruning when training. This leads to poor results when using a pruning algorithm such as one-shot pruning to prune a trained ML model. However, in the SDS process 100, the re-dense ML model 115 can be made more pruning-friendly by using techniques such as weight and/or data regularization (which will be discussed in more detail below).

The re-dense ML model 115 is then pruned again to generate another (sparse) output ML model 120. However, the output ML model 120 can have a smoother weight distribution and lower perplexity than the sparse ML model 110 since pruning was performed on the more pruning-friendly re-dense ML model 115. In one embodiment, the pruning technique used to generate the sparse ML model and the output ML model 120 from the initial ML model 105 and the re-dense ML model 115, respectively, can be the same pruning technique. However, in other embodiments, different pruning techniques may be used.

FIG. 1 also illustrates a computing system 150 that includes hardware and software for performing the SDS process 100. The system 150 includes a processor 155 and memory 160. The processor can represent one or more central processing units (CPUs), one or more graphics processing units (GPUs), or hardware accelerators (e.g., system on chips (SoCs), field programmable gate arrays (FPGAs), and the like). For example, the SDS process 100 may be performed on one or more GPUs.

The memory 160 can be implemented using volatile memory elements, nonvolatile memory elements, and combinations thereof. Here, the memory 160 stores pruning application 165 and reconstruction application 170, which can be separate software applications, or software modules in the same software application.

The pruning application 165 can perform the initial pruning and second pruning steps illustrated in FIG. 1. That is, the pruning application 165 can generate the sparse ML model 110 and the output ML model 120 from the initial ML Model 105 and the re-dense ML model 115, respectively. As mentioned above, the pruning application 165 can use the same pruning method in both pruning steps, or use different pruning algorithms.

The reconstruction application 170 generates the re-dense ML model 115 which may be more pruning-friendly than the initial ML model 105. In one embodiment, the reconstruction application 170 performs data and/or weight regularization to make the re-dense ML model 115 more pruning-friendly relative to the initial ML model 105. For example, the reconstruction application 170 may perform sparse regularization. Regularization introduces a penalty for complex models and encouraging the model to learn more generalized patterns to avoid overfitting. Sparse regularization guides parameter updates for a dense model, making that model more pruning (sparsification)-friendly. Regular regularization can be implemented as part of sparse regularization. The details of the pruning application 165 and the reconstruction application 170 are discussed below.

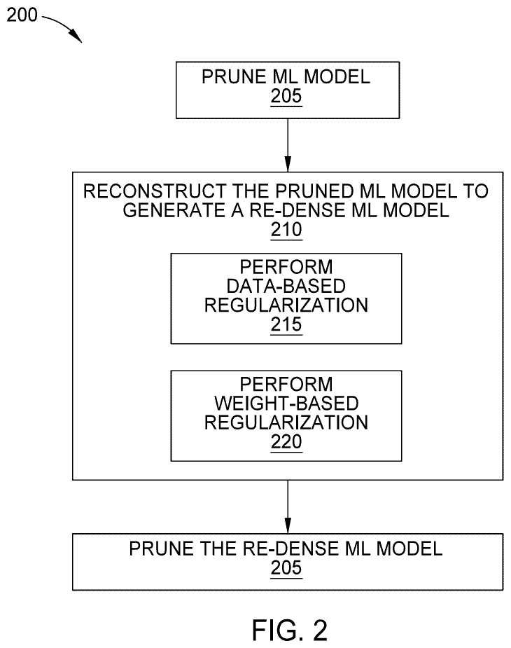

FIG. 2 is a flowchart of a method 200 for a SDS process, according to one embodiment. At block 205, a pruning application (e.g., the pruning application 165 in FIG. 1) prunes an ML model. In one embodiment, the ML model is a trained ML model. In one embodiment, the ML model is a PLM.

In one embodiment, the PLM model includes a transformer block that includes two main modules: a multi-head attention (MHA) layer and a feed-forward network (FFN) represented in the following equations:

$$X = MHA ( LayerNorm ( {X}_{l - 1} ) ) + {X}_{l - 1} \qquad ( 1 )$$

$${X}_{l} = FFN ( LayerNorm ( X ) ) + X \qquad ( 2 )$$

MHA can include h number of heads, represented as W^{O}*(Concat(head₁, head₂, . . . , headₕ). The i-th head can be expressed as:

$${head}_{i} = Attention ( {[ {W}^{Q} X ]}_{i} , {[ {W}^{K} X ]}_{i} , {[ {W}^{V} X ]}_{i} , M ) \qquad ( 3 )$$

$$Attention ( Q , K , V , M ) = softmax ( M ⊙ \frac{{QK}^{T}}{\sqrt{{d}_{k}}} ) V \qquad ( 4 )$$

where Q, K, and V represent the query, key, and value sequences, respectively, and their corresponding projection weights are W^{Q}, W^{K}, and W^{V}, dₖ is the dimension of the key vectors, and M is the mask matrix to selectively ignore or give weight to certain tokens in the input sequence. FFN expands and contracts input dimensions through hidden layers, introducing non-linearities to enhance representation learning, which can include two fully-connected layers, with their weights represented as W^{FC1}, W^{FC2}, respectively. The discussion below focuses on pruning the weights in fully-connected layers, which are emphasized by W^{Q}, W^{K}, W^{V}, W^{O}, W^{FC1} and W^{FC2} from the outset, but is not limited to pruning fully-connected layers.

In one embodiment, the pruning application performs unstructured pruning to eliminate (e.g., prune) less important connections to generate a sparse LLM. Sparsity improves LLM efficiency by reducing model size and computation. Unstructured pruning allows flexibility with no restrictions on mask positions, while n:m (semi-) structured pruning enforces a constraint that limits each group of m parameters to a maximum of n non-zero values.

The embodiments herein can be used with many different pruning techniques. One suitable technique leverages the Hessian matrix (H=XX^{T}) where X is the input to a weight matrix W to guide sparse mask selection and update the weights. Second-order information can be used to guide sparse mask selection and to modify weights. For example, given a particular sparsity, the pruning application compensates for the error that occurs during the pruning of the c-th column of a weight matrix W^{dense} by modifying the weights of subsequent columns (here we use subscripts for row and column indexes, omitting the layer number in the following equations).

$${W}_{: , c}^{sparse} = 1 ( sort ( \frac{{W}_{: , c}^{{dense}^{2}}}{{[ {H}^{- 1} ]}_{c , c}^{2}} ) > sparsity ) ⊙ {W}_{: , c}^{dense} , \qquad ( 5 )$$

$${W}_{: , c + 1 :}^{dense} = {W}_{: , c + 1 :}^{dense} - \frac{{( {W}_{: , c}^{dense} - {W}_{: , c}^{sparse} )}^{2}}{{[ {H}^{- 1} ]}_{c , c}^{2}} \cdot {[ {H}^{- 1} ]}_{: , c} \qquad ( 6 )$$

The Hessian matrix (H) in equations 5 and 6 identifies directions on the model's loss surface that have minimal curvature, corresponding to weights that minimally impact the performance.

Another suitable pruning technique uses weight update-free pruning by considering weight and activation magnitude. In one example, the pruning application performs a 2:4 semi-structured pruning which takes four parameters, two of which are non-zero.

Notably, the SDS process shown in method 200 can be performed using a small number of unlabeled samples for calibration, like conventional one-shot methods, which means the SDS process can performed in time frames that are similar to the one-shot methods.

At block 210, a reconstruction application (e.g., the reconstruction application 170 in FIG. 1) reconstructs the pruned ML model (e.g., the sparse ML model 110 in FIG. 1) to generate a re-dense ML model (e.g., the re-dense ML model 115 in FIG. 1.). As discussed above, one goal of reconstructing the ML model is to find a solution with pruning friendliness. In one embodiment, the reconstruction application implements layer-by-layer knowledge distillation with limited unlabeled samples to reactivate the connection in the pruned ML model. Doing so offers high efficiency while preserving the multitasking capabilities of the re-dense PLMs.

To avoid ending up with a re-dense solution resembling the initial dense ML model, the reconstruction application can inject sparse regularization into the re-dense process. Sparse regularization can be performed in three parts: a) Sparse inherited traits: the initial pruning cannot be omitted; it provides prior information about which weights are important for the re-dense weight reconstruction process (e.g., which weights were deemed important and thus were not pruned from the initial ML model). b) Data-based regularization on user data at sub-block 215: hard-to-learn samples are used as the inputs of re-dense weight reconstruction to avoid overfitting aberration. c) Weight-based regularization at sub-block 220: typical weight regularization is also employed to endow the re-dense weights with sparse features, thereby directly increasing the pruning friendliness. In one embodiment, the reconstruction application uses L1 regularization and L2 regularization, commonly referred to as weight decay. L1 is the L1 norm, which denotes the sum of the absolute values of the elements of a vector, often used in Lasso regularization. L2 is the L2 norm, which denotes the square root of the sum of the squares of the elements of a vector, often used in Ridge regularization.

According to the above three considerations, the re-dense weight reconstruction process is specified in the following. Given the original dense

$${W}_{l}^{dense}$$

in layer l, the sparse

$${W}_{l}^{sparse}$$

from the initial pruning step, and Xₗ₋₁ collected during the forward propagation of the sparse model, the re-dense weight

$${\hat{W}}_{l}^{re - dense}$$

is obtained by:

$${\hat{W}}_{l}^{re - dense} = {argmin}_{{W}_{l}^{sparse}} ( {‖ {W}_{l}^{dense} {X}_{l - 1} - {W}_{l}^{sparse} {X}_{l - 1} ‖}_{2}^{2} + {λ}_{1} {‖ {W}_{l}^{sparse} ‖}_{1} + {λ}_{2} {‖ {W}_{l}^{sparse} ‖}_{2}^{2} ) \qquad ( 6 )$$

where λ₁ and λ₂ are used to control the ratio of the L1 and L2 regularization. In one embodiment, they are set to be 0.1 by default.

The distribution of

$${\hat{W}}_{l}^{re - dense}$$

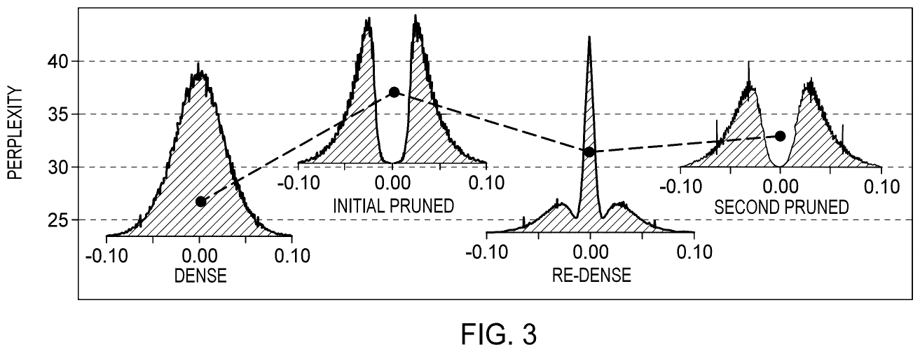

is shown in FIG. 3. Firstly, the parameters obtained through re-dense weight reconstruction show a clear three-peaked distribution. This distribution displays a higher sharpness around zero than the original dense model, which is an advantageous phenomenon. This indicates that weights with lower norms suppress irrelevant information for learning, a trait referred to as pruning-friendliness. Secondly, the re-dense weight reconstruction yields a model with performance slightly below that of the original dense model but significantly better than the pruned model generated at block 205. On the one hand, only a small amount of unlabeled data is used during the reconstruction phase. But the input Xₗ₋₁ is generated by the sparse model, which is challenging to optimize, thereby avoiding overfitting on simple samples.

In FIG. 3, initially, the dense weights follow a Gaussian distribution. After being pruned at block 205, a concentrated, bimodal distribution emerges (zero values are omitted in sparse weight distributions for better clarity). A three-peaked distribution is formed after performing connection reconstruction with sparse regularization to generate the re-dense ML model. Finally, the second pruning at block 225 of the method 200 (discussed below) attenuates the sharp peaks, resulting in a softer bimodal distribution. The dotted line represents the perplexity on raw-WikiText2. As shown, the second pruned model achieves a lower perplexity than the initially pruned one.

As a note, at block 210 the reconstruction application can inject sparse regularization to provide pruning-aware capabilities. Injecting awareness of subsequent operations into the model during pre-training or fine-tuning or reconstruction process, e.g., awareness of pruning, quantization, low-rank decomposition, etc., can be advantageous. Overall, the awareness of subsequent operations will be reflected in the weight initialization of the model. Some techniques that may be used to optimize weight includes (a) channel permutation and (b) weight equalization and bias correction.

In channel permutation, when two neighboring weights exist, the channels of the two can be rearranged without changing the inputs and outputs. Specifically, the channels in the inner product direction of the first weight can be permuted arbitrarily. Computational equivalence is maintained if the non-inner-product directions of the second weight are permuted in a manner consistent with the former. Channel permutation has the potential to distribute important and non-important weights more evenly, avoiding situations where all m weights are important or all m weights are unimportant in an n: m sparsity configuration. Channel permutation can pick an ideal result among several permutation candidates obtained from the search.

Weight equalization and bias correction can reduce the performance loss in quantization due to scale differences in layers or channels. Specifically, weight equalization multiplies each channel of the current layer by a set of scale factors to compress the span of weight values, while the weights of the previous layer are divided by the same scale factors in order to ensure computational equivalence. The bias corresponding to the weights can also be corrected to improve the model's performance, and related methods include scale smoothing, backpropagation, and so on. To protect outliers for quantizing PLMs, the above techniques have led to improved quantization techniques.

At block 225, the pruning application prunes the re-dense ML model generated at block 210. Directly adjusting weights in a sparse-to-sparse manner (i.e., without generating a re-dense ML model) can enhance a sparse model's performance; however, when applied to a model after the initial pruning stage, it may result in only minor performance gains on the lightest models. As shown in FIG. 3, pruning the weights of the initial model results in a sharp bimodal distribution. Such a stable and spiky distribution with low variance constrains the optimization potential. In addition, the benefits of knowledge distillation with unlabeled samples are not superior to those of task-specific fine-tuning.

Considering the aforementioned challenges, the pruning application performs sparse weight adjusting as the concluding step in the SDS framework. Firstly, the re-dense model obtained with sparse regularization guidance may perform inferior to the pre-trained model. As a result, directly pruning it may not be ideal. Therefore, performance optimization of the second-pruned model can result in performance gains. Secondly, after the re-dense model is pruned, its distribution tends to moderate, and thus there is more room for optimization. In one embodiment, the pruning application first prunes the re-dense model using the same method employed during the initial pruning, yielding W^{sparse-2nd}. Subsequently, weight adjusting is conducted using a soft sparse mask:

$${\hat{W}}_{l}^{SDS} = {M}_{l}^{soft} ⊙ ( arg {min}_{{W}_{l}^{sparse - 2 nd}} {‖ {W}_{l}^{dense} {X}_{l - 1} - {W}_{l}^{sparse - 2 nd} {X}_{l - 1} ‖}_{2}^{2} ) \qquad ( 7 )$$

where Xₗ₋₁ is also collected from the forward propagation of the second pruned model.

$${M}_{l}^{soft}$$

represents a soft sparse mask, which is dynamically selected by

$${W}_{l}^{sparse - 2 nd}$$

in each iteration. Due to the inherent awareness of activation information from backpropagation, the magnitude (absmin) mask selection metric can achieve results similar to the Hessian metric in or an activation-aware metric. In both steps of weight adjustment, the L2 loss can be utilized, inherently emphasizing the loss in regions with outliers which is advantageous in the performance of language models. Therefore, outliers can be protected and less affected by weight adjustments.

As shown in FIG. 3, the weight presented after the second pruning becomes moderate, i.e., the weight distribution of the second-pruned model is smoother and more uniform than that of the initial pruning step, which means that the model parameters have suitable values in different ranges, possessing a stronger ability to adapt to unseen data.

Once a second sparse ML model is generated at block 225, this sparse ML model (e.g., a sparse PLM) can then be executed on the computing system to answer user queries.

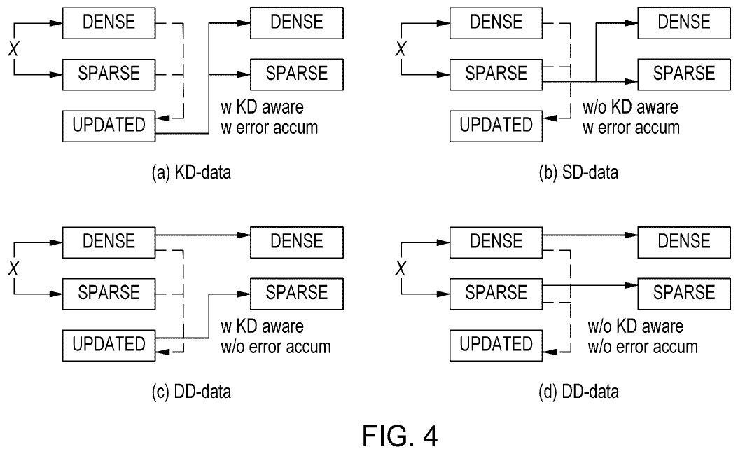

FIG. 4 illustrates error accumulation and weight regularization according to one embodiment. For example, FIG. 4 can illustrate the weight regularization performed at sub-block 220 of the method 200.

The input data used in weight adjustment can be categorized in two ways: whether to perform error accumulation and whether to be aware of the knowledge distillation (KD) process. FIG. 4 presents four different data selection ways for weight adjustment. (a) Weight adjustment with KD aware and error accumulation, this paradigm corresponds to KD-data: after applying KD to the sparse layer, a subsequent forward propagation is used to generate inputs for the next layer. In one embodiment, these inputs are solely based on the former layer's outputs, thus accumulating errors. Since KD aims to reduce loss, this extra forward propagation simplifies the data, making it easier for the subsequent layer to learn. (b) Weight adjustment with error accumulation but without KD aware: this paradigm corresponds to SD-data. Unlike paradigm (a), this approach abandons the additional forward propagation to account for changes in the layer updated by KD. This results in the next layer of learning from data corresponding to a higher loss, making learning more challenging than in paradigm (a). Paradigms (c) and (d) are two ways of adjusting the weights without accumulating errors. The presence or absence of KD awareness has a minimal impact on either, as the optimization direction is constrained by the same dense model in both cases.

From the perspective of data difficulty, DD-data is the most difficult because each layer compensates for the errors accumulated in all previous layers. This difficulty is more prominent in the KD process under sparsity constraints.

KD-data is the easiest because the weights of the sparse model are updated in the direction of lower loss during knowledge distillation. The use of KD-data has yielded relatively good results only in single-step optimization of the sparse model due to the fact that simple data carries less data regularization and a relatively low upper bound for optimization.

SD-data is relatively moderate in difficulty and comes with data regularization and hence achieved an ideal result in SDS's optimization of the sparse model.

Not only the weight adjustment but also the pruning process faces the issue of data selection. In the absence of weight adjustment, the only data available for the pruning process are DD-data and SD-data (KD-data degenerates into SD-data). DD-data can be considered as ideal data, and SD-data can be considered as real data (the absence of knowledge distillation makes the data difficulty perspective less appropriate).

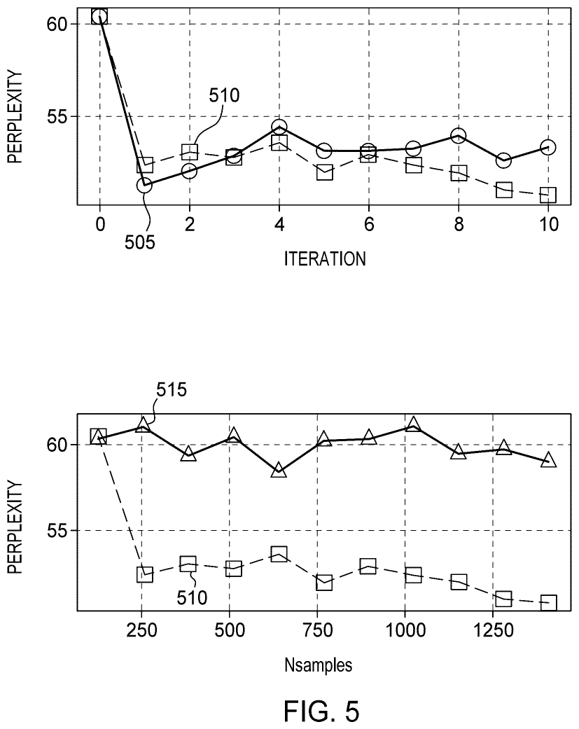

FIG. 5 illustrates results of iteratively applying the SDS framework using static and dynamic samples, according to one embodiment. That is, FIG. 5 illustrates The impact of iteratively applying the SDS framework discussed above, specifically contrasting the outcomes when employing either identical samples (Static SDS) or varied samples (Dynamic SDS) throughout the process. The left chart in FIG. 5 illustrates a comparison between static SDS as shown in plot 505 and dynamic SDS as shown in plot 505 across multiple iterations. The right chart in FIG. 5 demonstrates a comparison between a one-shot pruning technique (plot 515) and dynamic SDS (which is the same plot 510 as in the left chart), depicting variations in performance as the size of the calibration set changes.

Grounded in SDS, FIG. 5 illustrates that iteratively applying the SDS framework can further improve the performance of the model. The plot 505 indicates the impact on model performance of using exactly the same samples as a calibration set in the iterations (Static SDS) so that the number of samples used in the optimization remains 128. The plot 510 illustrates the effect of using different samples in each iteration on the model's performance (Dynamic SDS), i.e., at iteration i, the optimization uses a sample size of i×128.

As shown left chart in FIG. 5, implementing dynamic SDS once (Iteration 1) compared to a one-shot pruning technique (Iteration 0) can result in large improvements, whether using the same or different calibration samples. However, as the number of iterations increased, implementing the SDS optimization multiple times with the same calibration samples may have little improvement on the model's performance. This may be because the model that is optimized excessively on the same batch of samples is prone to overfitting, leading to performance degradation. When different samples were used, improved results to a single implementation of SDS were produced. This demonstrates that data diversity can positively affect the iterative SDS optimization process. However, iteratively performing the SDS framework can result performance that does not strictly increase monotonically, which may mean that the inclusion of high-quality samples may have resulted in substantial contributions.

The right chart of FIG. 5 demonstrates that more samples can bring substantial performance gains to the SDS iterative optimization process compared to prior one-shot pruning techniques. While using different samples can result in a better-performing model, these samples still come from the same distribution, and there is a risk of overfitting by having the model optimized with the samples as the calibration set many times. Therefore, optimizing with a small number of unlabeled samples less frequently may be preferred over iteratively implementing SDS framework as shown in FIG. 5.

As discussed herein, the SDS framework for optimizing, e.g., pruned generative PLMs, consisting of initial pruning, re-dense weight reconstruction, and a second pruning round. The SDS framework may focus on weight distribution optimization and incorporate sparse regularization elements—including inherited traits, data-based regularization, and weight-based regularization. As a result, SDS not only enhances the model's pruning friendliness but also achieves state-of-the-art pruning results. Experimental results show that SDS surpasses one-shot pruning techniques by reducing language comprehension perplexity by, for example, an average of 6.4 and increasing the overall accuracy by 1.8% across multiple downstream tasks on different PLMs.

In the preceding, reference is made to embodiments presented in this disclosure. However, the scope of the present disclosure is not limited to specific described embodiments. Instead, any combination of the described features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the preceding aspects, features, embodiments and advantages are merely illustrative and are not considered elements or limitations of the appended claims except where explicitly recited in a claim(s).

As will be appreciated by one skilled in the art, the embodiments disclosed herein may be embodied as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium is any tangible medium that can contain, or store a program for use by or in connection with an instruction execution system, apparatus or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various examples of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to specific examples, other and further examples may be devised without departing from the basic scope thereof, and the scope thereof is determined by the claims that follow.

What is claimed is:

1. A computing system, comprising:
one or more processors; and
memory storing one or more applications configured to, when executed by the one or more processors, perform operations, the operations comprising:
pruning a machine learning (ML) model to generate a sparse ML model;
reconstructing the pruned ML model to generate a re-dense ML model; and
pruning the re-dense ML model.

2. The computing system of claim 1, wherein reconstructing the pruned ML model comprises performing sparse regularization.

3. The computing system of claim 2, wherein sparse regularization comprises performing data-based regularization and weight-based regularization on user data and weights in the pruned ML model.

4. The computing system of claim 2, wherein performing sparse regularization results in the re-dense ML model being more pruning-friendly than the ML model.

5. The computing system of claim 2, wherein the sparse regularization comprises L1 and L2 regularization.

6. The computing system of claim 1, wherein a same pruning technique is used when pruning the ML model and when pruning the re-dense ML model.

7. The computing system of claim 1, wherein the ML model is a pre-trained language model (PLM), wherein pruning the re-dense ML model results in a sparse PLM, the operations further comprising:
executing the sparse PLM to answer user queries.

8. A method, comprising:
pruning, using a computing system, a machine learning (ML) model to generate a sparse ML model;
reconstructing, using the computing system, the pruned ML model to generate a re-dense ML model; and
pruning, using the computing system, the re-dense ML model.

9. The method of claim 8, wherein reconstructing the pruned ML model comprises performing sparse regularization.

10. The method of claim 9, wherein sparse regularization comprises performing data-based regularization and weight-based regularization on user data and weights in the pruned ML model.

11. The method of claim 9, wherein performing sparse regularization results in the re-dense ML model being more pruning-friendly than the ML model.

12. The method of claim 9, wherein the sparse regularization comprises L1 and L2 regularization.

13. The method of claim 8, wherein a same pruning technique is used when pruning the ML model and when pruning the re-dense ML model.

14. The method of claim 8, wherein the ML model is a pre-trained language model (PLM).

15. The method of claim 14, wherein the PLM comprises a transformer block.

16. The method of claim 14, wherein pruning the re-dense ML model results in a sparse PLM, the method further comprising:
executing the sparse PLM to answer user queries.

17. A non-transitory computer readable medium storing instructions that, when executed by one or more processors, causes the one or more processors to, individually or collectively perform operations, the operations comprising:
pruning a machine learning (ML) model to generate a sparse ML model;
reconstructing the pruned ML model to generate a re-dense ML model; and
pruning the re-dense ML model.

18. The non-transitory computer readable medium of claim 17, wherein reconstructing the pruned ML model comprises performing sparse regularization, wherein sparse regularization comprises performing data-based regularization and weight-based regularization on user data and weights in the pruned ML model.

19. The non-transitory computer readable medium of claim 18, wherein the sparse regularization comprises L1 and L2 regularization.

20. The non-transitory computer readable medium of claim 17, wherein pruning the re-dense ML model results in a sparse PLM, the operations further comprising:
executing the sparse PLM to answer user queries.
